(19) United States
(12) Patent Application Publication
(10) Pub. No.: US 2013/0146527 A1
(43) Pub. Date: Jun. 13, 2013

(54) FILTER ELEMENT FOR FILTERING FLUIDS

(71) Applicants: Volker Grobe, Weimar-Tiefurt (DE); Uwe Fries, Jena (DE); Frank Oberli, Eglisau (CH)

(72) Inventors: Volker Grobe, Weimar-Tiefurt (DE); Uwe Fries, Jena (DE); Frank Oberli, Eglisau (CH)

(21) Appl. No.: 13/261,568

(22) PCT Filed: Jul. 22, 2011
(86) PCT No.: PCT/EP2011/003687

§ 371 Date: Feb. 22, 2013

(30) Foreign Application Priority Data
Jul. 22, 2010 (DE) 10 2010 031 842.6

(51) Int. Cl. B01D 29/11

(52) U.S. Cl. CPC B01D 29/11
USPC 210/484

(57) ABSTRACT

The invention relates to a filter element for filtering fluids, comprising a flat support structure which forms the wall of a support tube (1) which surrounds the exterior of a filter medium and forms a through-flow surface and a marking surface (9), the through-flow surface having through-flow apertures (5) forming a perforation pattern (3) and the marking surface (9) having visibly discernible marking elements (11). The filter element is characterized in that the marking elements (11) are formed in the marking surface (9) by a second perforation pattern (13) which contrasts with the perforation pattern (3) of the through-flow surface in a visibly discernible manner.

The invention relates to a filter element for filtering fluids, comprising a flat support structure which forms the wall of a support tube which surrounds the exterior of a filter medium and forms a through-flow surface and a marking surface, with the through-flow surface having through-flow apertures that form a perforation pattern and the marking surface having visually discernible marking elements.

In order to operate such filter devices that are used, for example, in hydraulic systems for filtering hydraulic fluids or in other systems for filtering fuels, lubricants, or other operating media, good performance of the filter elements that are used is the key criterion. In this case, the essential aspects are a pressure-tight support of the filter media against the acting flow forces, a feature that requires that the respective support structures exhibit high mechanical strength and that this support structure generate a minimum amount of flow resistance. In order to meet these requirements, the state of the art provides through-flow apertures in the form of a perforation pattern in the wall of the support structure, so that an acceptable compromise between structural strength and fluid permeability can be reached.

Such filter elements often require visually discernible markings to be affixed on the exterior. In order to satisfy this requirement, it is customary to provide a marking surface, which can be distinguished from the through-flow surface inside the surface of the support structure. In this case, the marking elements in the form of visually legible characters, for example, the manufacturer's designation or specification data, are printed on the marking surface. The drawback with this approach is that the through-flow surface is interrupted by the marking surface; and this break leads in turn to a reduction in the total flow surface area, which is defined by the addition of the perforation cross sections of the perforation pattern, so that when markings are affixed, an increase in flow resistance has to be tolerated.

With respect to this problem, the object of the present invention is to provide a filter element in which the affixing of markings is associated with a comparatively lower loss of effective flow surface area.

The invention achieves this object by means of a filter element having the features specified in claim 1 in its entirety.

According to the characterizing part of claim 1, an essential feature of the invention lies in the fact that marking elements are formed in the marking surface by a second perforation pattern which contrasts with the perforation pattern of the through-flow surface in a visually discernible manner. As a result, the marking surface does not form a continuous blocking surface, but rather forms additional through-flow apertures because the marking elements are formed by a perforation forming a second perforation pattern; that is, the marking itself forms, with the perforation pattern of the marking elements, an additional through-flow surface inside the marking surface. Especially in the case of markings with marking elements in the form of capital letters, such an arrangement allows a large part of the marking surface to be configured as an additional through-flow surface. At the same time, a good visual recognition is ensured, even if a large part of the marking surface is filled with the second perforation pattern.

In embodiments in which the second perforation pattern differs from the first perforation pattern, which may be found in the through-flow surface due to a deviating perforation size, preferably a smaller perforation size, the marking visually contrasts with the first perforation pattern so as to be particularly easy to discern.

At the same time, the arrangement can be configured in such a way that at least one perforation pattern, preferably the first perforation pattern, exhibits rectangular perforations. Such perforation patterns are distinguished by a good compromise between mechanical strength and low flow resistance.

The arrangement can also be configured in such a way that at least one perforation pattern exhibits round perforations. If in this case the second perforation pattern of the marking elements is formed with round perforations and the first perforation pattern has rectangular perforations, then the marking elements contrast with the surrounding first perforation pattern in an especially conspicuous way.

The support structure can consist of a one-piece support tube that substantially surrounds the entire exterior of a cylindrical filter material.

Especially in the case of filter devices that are used in large systems, where the filter devices use filter elements having large dimensions and the associated outer support tubes of the filter elements are components of relatively large format, the arrangement can be configured in such an advantageous way that a support tube, which surrounds the exterior of a cylindrical filter material, is formed from a winding consisting of a plurality of support structure members in strip form. Of these support structure members, at least one support structure member is provided with a second perforation pattern that forms the marking elements.

The invention is explained in detail below with reference to the drawings. Referring to the drawings:

FIG. 1 is a highly simplified perspective view in schematic form of a flat support structure in the form of an outer support tube for a filter element, which, otherwise, is not illustrated;

FIG. 2 shows a cutout of the surface of the support structure of a filter element according to the state of the art; and this surface cutout is shown on a larger scale compared to FIG. 1 and is depicted in a stretched, planar state;

FIG. 3 is a top view of the support structure, which is also shown in a planar, stretched state for an exemplary embodiment of the filter element according to the invention;

FIG. 4 is a top view, similar to FIG. 3, of a segment of a part of a structural element having a strip shape for the purpose of forming a wound support tube for a modified exemplary embodiment of the filter element according to the invention;

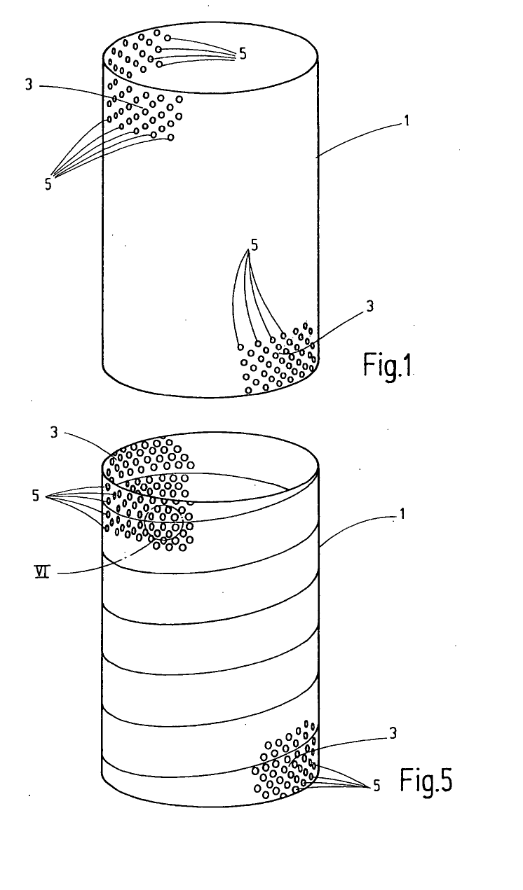

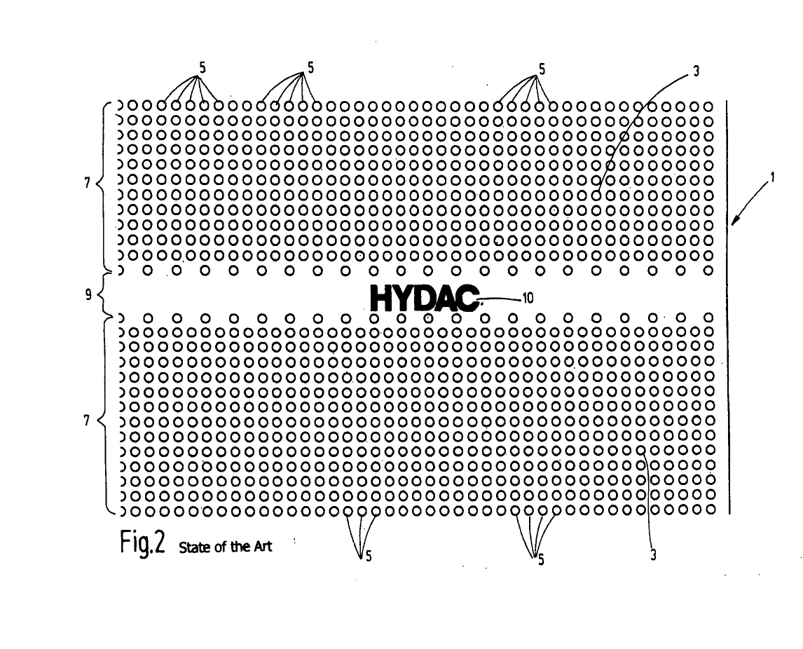

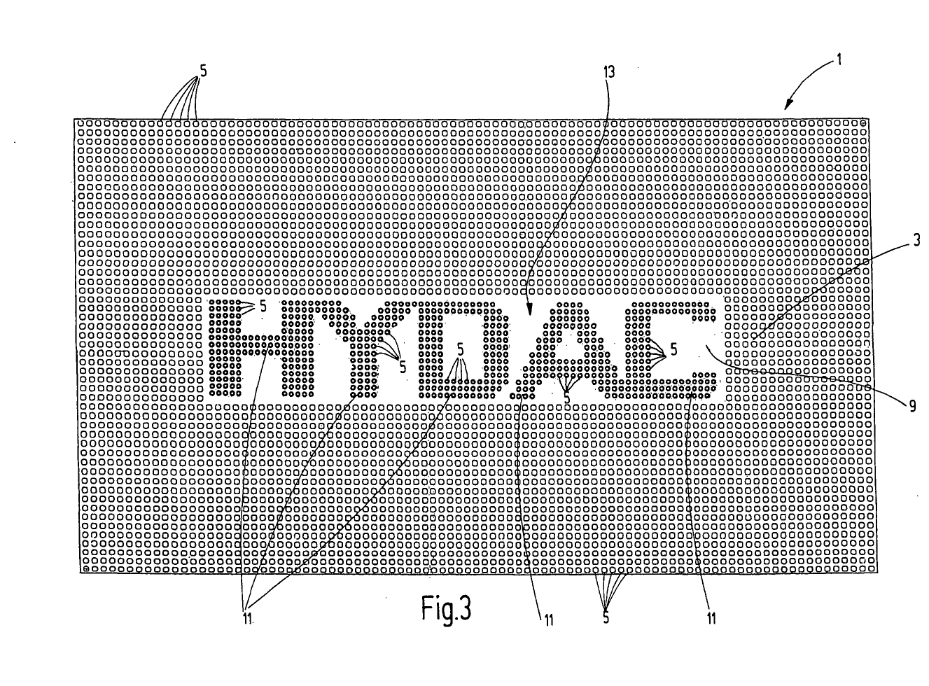

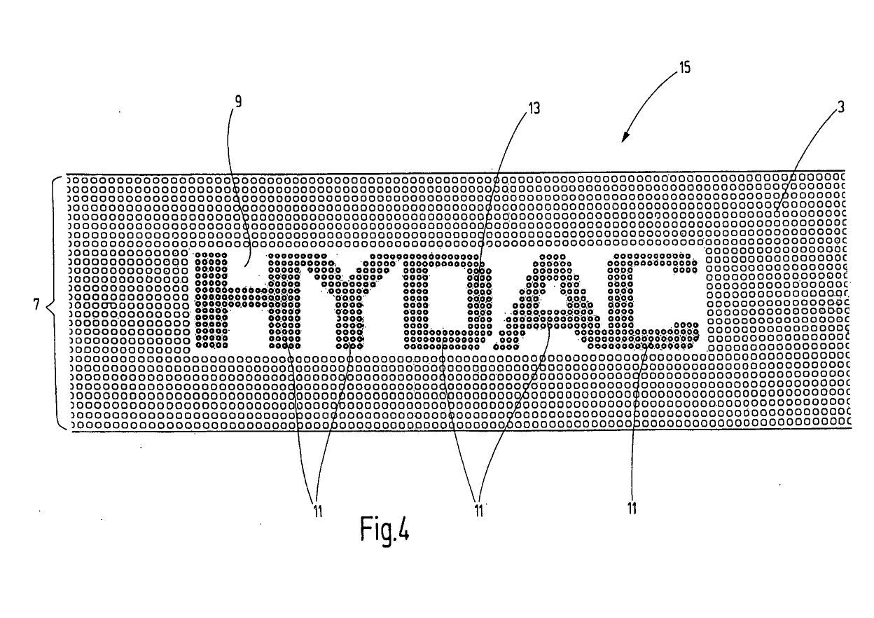

FIG. 5 is a highly simplified perspective view in schematic format of the support tube that is wound with the support structure member from FIG. 4;

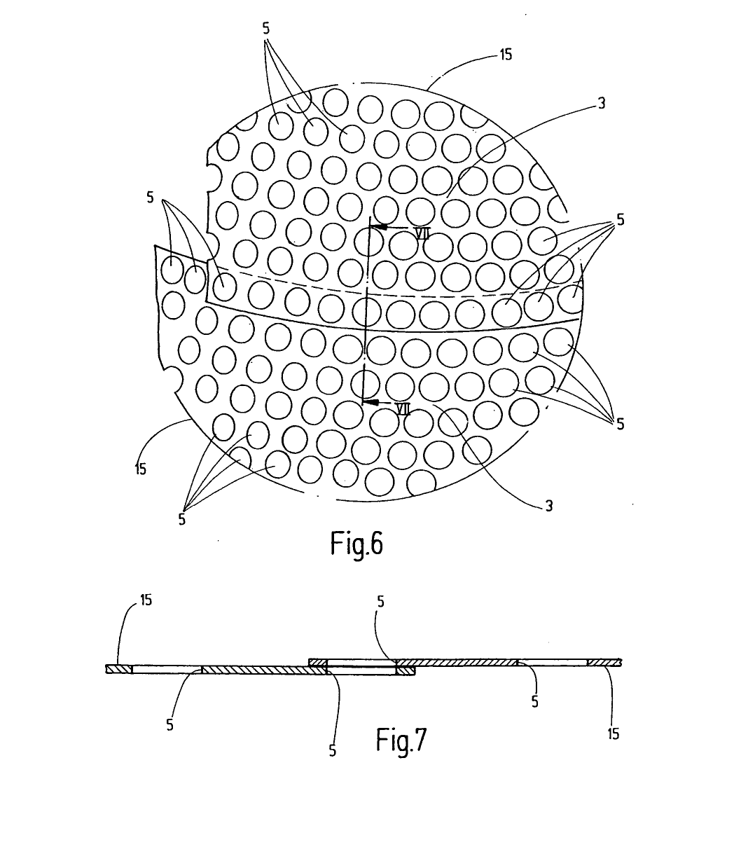

FIG. 6 is a greatly enlarged segment of the region of the support tube that is designated as VI in FIG. 5, and

FIG. 7 is a sectional view that is shown on a larger scale compared to FIG. 6 and corresponds to the line VII-VII from FIG. 6.

FIG. 1 is a highly simplified representation of a support structure in the form of an outer support tube 1 for a filter element. The support tube I surrounds the exterior of a filter medium (not illustrated), which can be constructed in the conventional manner, for example, in the form of a multi-layered filter mat web, which can be folded in the manner of pleats and can be brought into the shape of a cylindrical hollow body. The wall of the support tube 1 forms a through-flow surface 7, in which the through-flow apertures form a perforation pattern 3 for the passage of fluids. Only some of the perforations 5 of the perforation pattern are shown and numbered in FIG. 1.

FIG. 2 shows one section of a surface (in a planarly stretched form) for a support tube 1 of a filter element according to the state of the art. In order to affix on the support tube 1 a visually discernible marking, in the present case in the form of lettering 10, in the wall of the support tube 1, in addition to the through-flow surface 7, there is a marking surface 9, which has no perforations 5 for printing a marking thereon. The presence of the marking surface 9 leads to a reduction in the total open surface having no perforations with a corresponding increase in flow losses when the respective filter element is in operation.

In contrast, FIG. 3 shows a support tube 1 (in the stretched form, which is not rolled into a cylinder) for a filter element according to one exemplary embodiment of the invention. The marking surface 9, which may be found inside the through-flow surface 7, has a marking with marking elements 11 in the form of capital letters. The marking elements 11 are formed by a second perforation pattern 13, which contrasts with the first perforation pattern 3, which may be found in the through-flow surface 7, in a visually discernible manner. In the example, shown in FIG. 3, the first perforation pattern 3 is formed by perforations 5 having a rectangular shape; and these perforations are arranged in aligned lines and columns by punching. The second perforation pattern 13 is formed from perforations 5, which have a smaller perforation size and a round perforation shape, for good visual distinctness relative to the perforations 5 of the first perforation pattern 3. It is obvious that it would also be possible to achieve easy visual distinctness if other shapes or sizes of the perforations were provided for the first perforation pattern 3 and/or the second perforation pattern 13. In the example shown in FIG. 3, the perforations 5, which may be found in the through-flow surface 7 of the first perforation pattern 3, have a rectangular shape. In comparison to a perforation pattern with round perforations, such a configuration produces a lower flow resistance at the same structural strength. Since the marking elements 11 are formed by the second perforation pattern 13, the marking surface 9 is provided with an additional through-flow surface, so that the affixing of a marking implies a comparatively lower loss of the effective total through-flow surface area.

FIG. 3 shows a support tube 1, which surrounds in one piece, as the support structure, the entire exterior of the respective filter material. If filter elements having especially large dimensions are involved, then the support tube 1 can be formed from a winding consisting of one or more structural members 15 in strip form. Of these structural members, FIG. 4 shows one longitudinal section. This longitudinal section in turn, as also shown in FIG. 3, is provided with a marking surface 9 inside the through-flow surface 7. Inside this marking surface, the corresponding marking elements 11 are formed by a second perforation pattern 13, which differs visually from the first perforation pattern 3 in the through-flow surface 7. A corresponding marking surface 9 could also be provided in one or more longitudinal sections of the structural member 15 in strip form.

FIGS. 5 to 7 elucidate the formation of a support tube 1 that is fabricated in a wound type of construction. In FIG. 5, as also in FIG. 1, only some of the perforations 5 of the first perforation pattern 3 are indicated and numbered. FIG. 6 shows an enlarged cutout depicting in greater detail the region designated as VI in FIG. 5. FIG. 6 shows very clearly that formation of the winding of the strip is performed by laying the edges of the adjacent structural members 15 alongside each other with the edges overlapping so that the perforations 5 of the outermost row of perforations of both adjacent structural members 15 overlap and, as a result of the overlapping, there is no loss of effective through-flow surface. See also the enlarged sectional view in FIG. 7.

The joining at the overlapping region of the edges can be performed, for example, by gluing or welding. A sheet metal, which is suitable for hole punching and is corrosion-resistant to the media to be filtered, can be used as the material for the support structure formed by the support tube 1. In this respect, it can be a hot dip laminated sheet metal (Zincor®), which can be galvanized, so that the joint points of adjacent structural members 15 can be soldered.

The perforation patterns 3, 13 can be made in a number of ways by, for example, laser cutting, etching, or, in the case of materials that lend themselves to hole punching in an advantageous way, punching. At the same time, the procedure can be carried out in such a way that the web of material that is provided for punching the perforations is conveyed through a punching device in the feed direction. This punching device comprises a number of stamping punches that match the lines of perforations that are to be formed. In this context, at least groups of hole punches can be controlled independently of other hole punches or groups of hole punches in order to form the second perforation pattern 13 that contrasts with the first perforation pattern 3. At the same time, the hole punches of the group forming the second perforation pattern 13 can be controlled in turn independently of each other in order to represent the marking elements 11, for example, in the form of letters, as the pattern shape. It is self-evident that that hole punches of the individual groups can punch the different shapes and/or sizes of the respective perforations.

1. A filter element for filtering fluids, comprising a flat support structure which forms the wall of a support tube (1) which surrounds the exterior of a filter medium and forms a through-flow surface (7) and a marking surface (9), with the through-flow surface (7) having through-flow apertures (5) that form a perforation pattern (3) and the marking surface (9) having visually discernible marking elements (11), characterized in that marking elements (11) are formed in the marking surface (9) by a second perforation pattern (13) which contrasts with the perforation pattern (3) of the through-flow surface (7) in a visually discernible manner.

2. The filter element according to claim 1, characterized in that the second perforation pattern (13) differs from the first perforation pattern (3), which may be found in the through-flow surface (7), due to a deviating perforation size, preferably a smaller perforation size.

3. The filter element according to claim 1, characterized in that the second perforation pattern (13) differs from the first perforation pattern (3), which may be found in the through-flow surface (7), due to a deviating perforation shape.

4. The filter element according to claim 1, characterized in that at least one perforation pattern (3, 13), preferably the first perforation pattern (3), has rectangular perforations (5).

5. The filter element according to claim 1, characterized in that at least one perforation pattern (3, 13) has round perforations (5).

6. The filter element according to claim 1, characterized in that the perforations (5) of at least one perforation pattern (3, 13) are arranged in lines and columns that are in alignment with each other.

7. The filter element according to claim 1, characterized in that the marking elements (11), formed by the second perforation pattern (13), form alphanumeric characters, in particular letters or numbers.

8. The filter element according to claim 1, characterized in that the support structure is a one-piece support tube (1) that substantially surrounds the entire exterior of a cylindrical filter material.

9. The filter element according to claim 1, characterized in that the exterior of a support tube (1), which surrounds a cylindrical filter material, is formed from a winding consisting of one or more structural members (15) in strip form; and of these structural members at least one structural member (15) is provided with a second perforation pattern (13) that forms the marking elements (11).
